(19) United States
(12) Patent Application Publication
(10) Pub. No.: US 2016/0174195 A1
(43) Pub. Date: Jun. 16, 2016

(54) EMBMS AUDIO PACKETS PROTECTION IN DUAL-SIM DUAL-STANDBY OR SRLTE MOBILE DEVICE

(71) Applicant: QUALCOMM Incorporated, San Diego, CA (US)

(72) Inventors: Kuo-Chun LEE, San Diego, CA (US); Sivaramakrishna VEEREPALLI, San Diego, CA (US); Shailesh MAHESHWARI, San Diego, CA (US); Daniel AMERGA, San Diego, CA (US); Jack Shyh-Hurng SHAUH, San Diego, CA (US); Mohan Krishna GOWDA, San Diego, CA (US); Ralph Akram GHOLMIEH, San Diego, CA (US); Nagaraju NAIK, San Diego, CA (US); Nermeen Ahmed BASSIOUNY, San Diego, CA (US); Thadi Manjunath NAGARAJ, San Diego, CA (US)

(21) Appl. No.: 14/949,674

(22) Filed: Nov. 23, 2015

Related U.S. Application Data
(60) Provisional application No. 62/090,711, filed on Dec. 11, 2014.

(51) Int. Cl. H04W 72/00; H04L 29/08; H04W 36/08

(52) U.S. Cl. CPC H04W 72/005; H04W 36/08; H04L 67/06

(57) ABSTRACT

A method, an apparatus, and a computer program product for wireless communication are provided. The apparatus determines a timing of each of one or more audio transmissions of one or more audio segments through Multimedia Broadcast Multicast Service (MBMS) streaming via a first radio access technology (RAT), where the MBMS streaming includes the one or more audio segments and one or more video segments. The apparatus refrains from tuning away from the first RAT to a second RAT during at least one audio transmission of the one or more audio transmissions, the second RAT being different than the first RAT.

### CROSS-REFERENCE TO RELATED APPLICATION(S)

This application claims the benefit of U.S. Provisional Application Ser. No. 62/090,711, entitled “EMBMS AUDIO PACKETS PROTECTION IN DUAL-SIM DUAL-STANDBY OR SRLTE MOBILE DEVICE” and filed on Dec. 11, 2014, which is expressly incorporated by reference herein in its entirety.

### BACKGROUND

1. Field

The present disclosure relates generally to communication systems, and more particularly, to a Multimedia Broadcast Multicast Service streaming.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of a telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer-readable medium, and an apparatus are provided. The apparatus may be a user equipment (UE). The apparatus determines a timing of each of one or more audio transmissions of one or more audio segments through Multimedia Broadcast Multicast Service (MBMS) streaming via a first radio access technology (RAT), where the MBMS streaming includes the one or more audio segments and one or more video segments. The apparatus refrains from tuning away from the first RAT to a second RAT during at least one audio transmission of the one or more audio transmissions, the second RAT being different than the first RAT.

In an aspect of the disclosure, an apparatus may be a UE. The apparatus includes means for determining a timing of each of one or more audio transmissions of one or more audio segments through MBMS streaming via a first RAT, where the MBMS streaming includes the one or more audio segments and one or more video segments. The apparatus includes means for refraining from tuning away from the first RAT to a second RAT during at least one audio transmission of the one or more audio transmissions, the second RAT being different than the first RAT.

In an aspect of the disclosure, an apparatus may be a UE. The apparatus includes a memory and at least one processor coupled to the memory. The at least one processor is configured to: determine a timing of each of one or more audio transmissions of one or more audio segments through MBMS streaming via a first RAT, where the MBMS streaming includes the one or more audio segments and one or more video segments, and refrain from tuning away from the first RAT to a second RAT during at least one audio transmission of the one or more audio transmissions, the second RAT being different than the first RAT.

In an aspect of the disclosure, a computer-readable medium storing computer executable code for wireless communication comprises code for: determining a timing of each of one or more audio transmissions of one or more audio segments through MBMS streaming via a first RAT, where the MBMS streaming includes the one or more audio segments and one or more video segments, and refraining from tuning away from the first RAT to a second RAT during at least one audio transmission of the one or more audio transmissions, the second RAT being different than the first RAT.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7A is a diagram illustrating an example of an evolved Multimedia Broadcast Multicast Service channel configuration in a Multicast Broadcast Single Frequency Network.

FIG. 7B is a diagram illustrating an example of an MBSFN area.

FIG. 7C is a diagram illustrating a format of a Multicast Channel Scheduling Information Media Access Control control element.

FIG. 8 is a first example diagram illustrating communication of DASH segments over one RAT and paging via another RAT.

FIG. 9 is a second example diagram illustrating communication of DASH segments over one RAT and paging via another RAT.

FIG. 10 illustrates an example structure of an IP packet.

FIG. 11A is a first example diagram illustrating communication of DASH segments over one RAT, paging via another RAT, and refraining from tuning away, according to an aspect of the disclosure.

FIG. 11B is a diagram illustrating an example tune-away duration in relation to the first example diagram of FIG. 11A.

FIG. 12A is a second example diagram illustrating communication of DASH segments over one RAT, paging via another RAT, and refraining from tuning away, according to an aspect of the disclosure.

FIG. 12B is a diagram illustrating an example tune-away duration in relation to the second example diagram of FIG. 12A.

FIG. 13 is a flow chart of a method of wireless communication.

FIG. 14 is a conceptual data flow diagram illustrating the data flow between different means/components in an exemplary apparatus.

FIG. 15 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer. In an aspect, computer-readable media may be non-transitory computer-readable media.

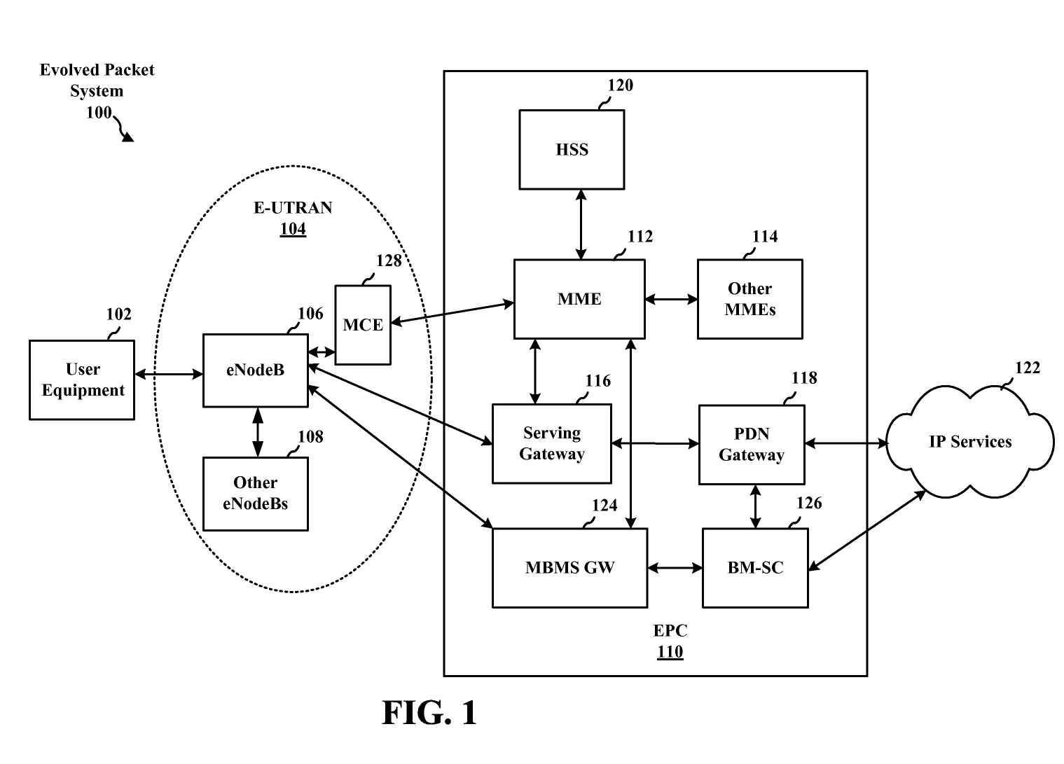

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a public land mobile network (PLMN), and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

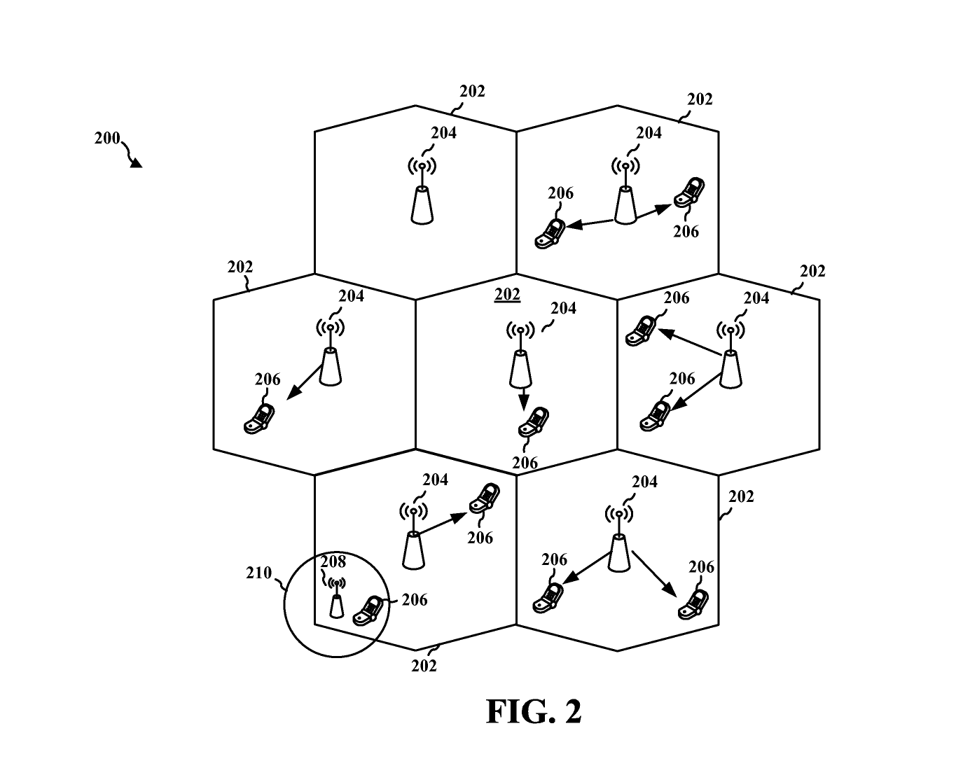

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sectors). The term “cell” can refer to the smallest coverage area of an eNB and/or an eNB subsystem serving a particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

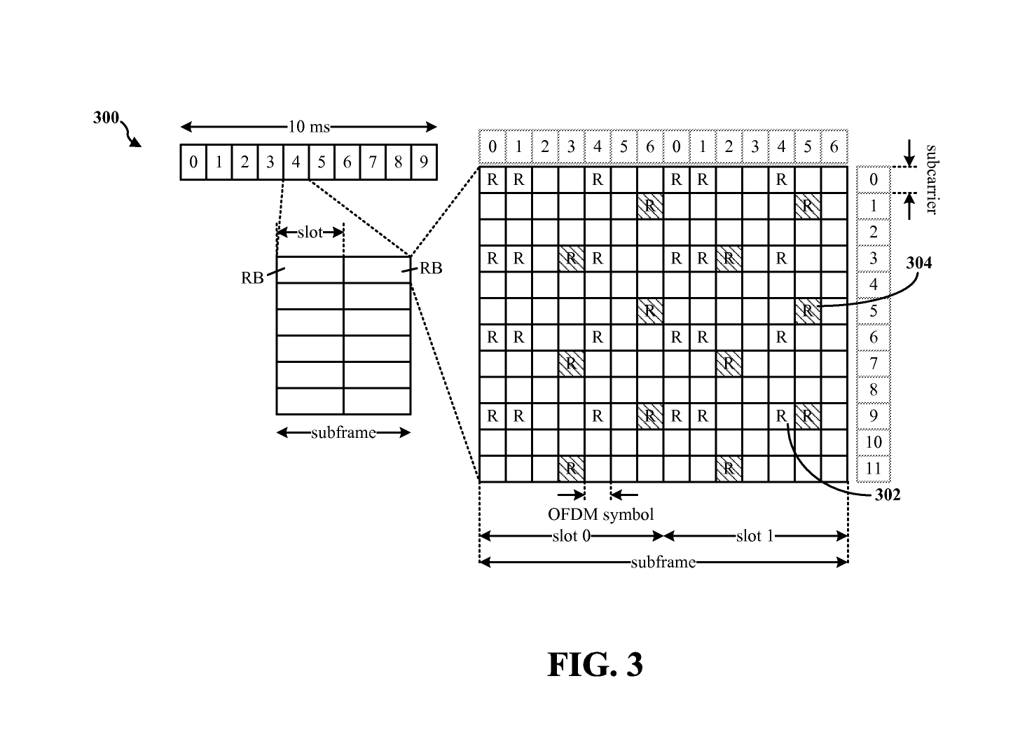

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

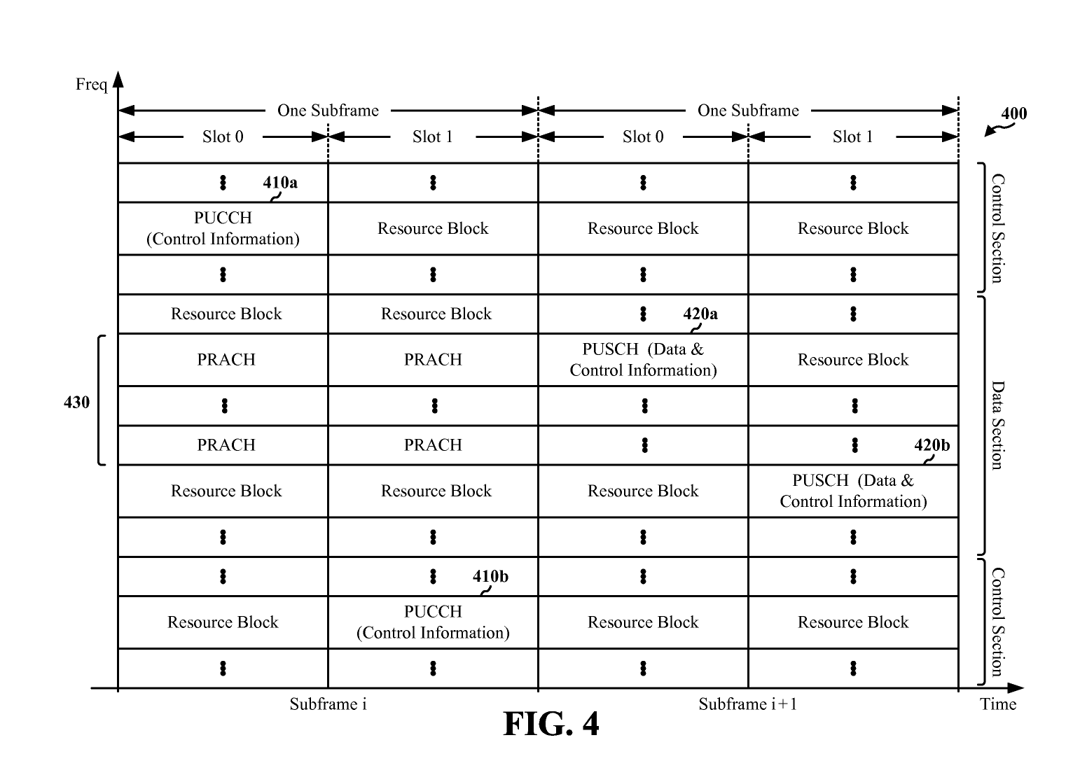

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make a single PRACH attempt per frame (10 ms).

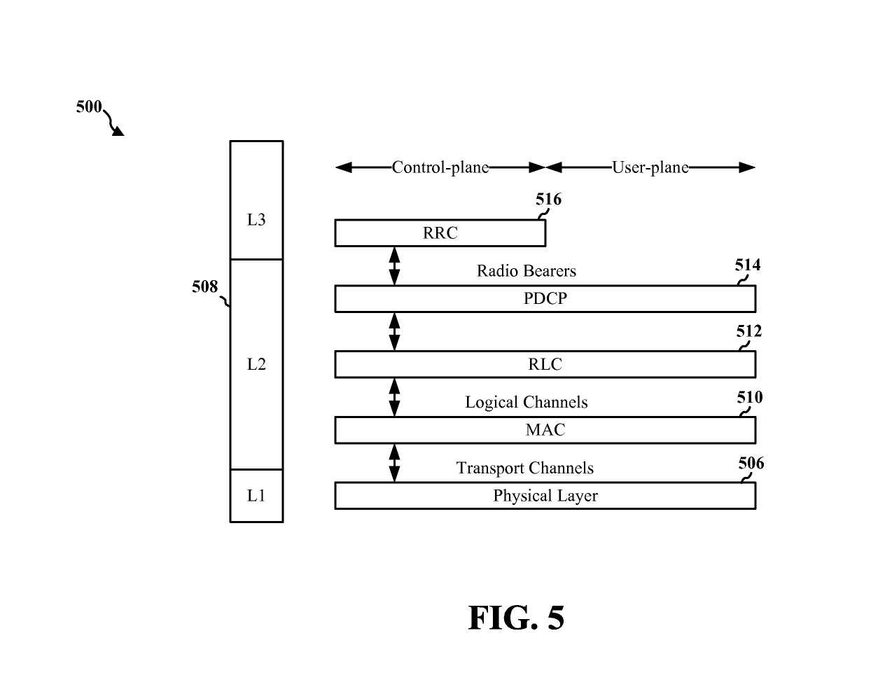

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

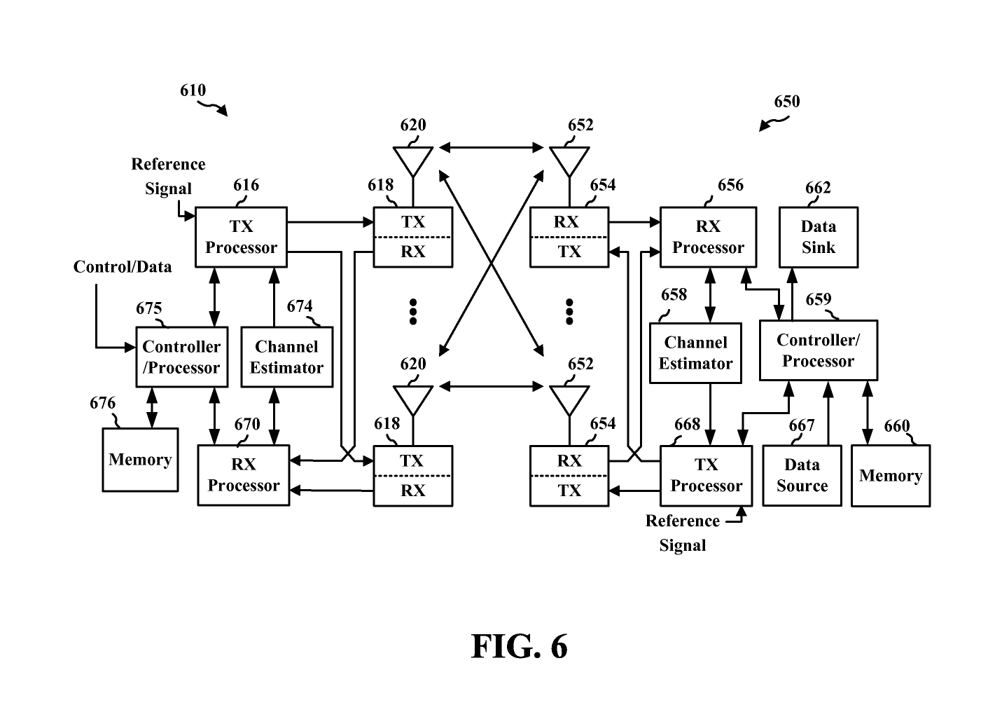

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each sub carrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor 659 can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

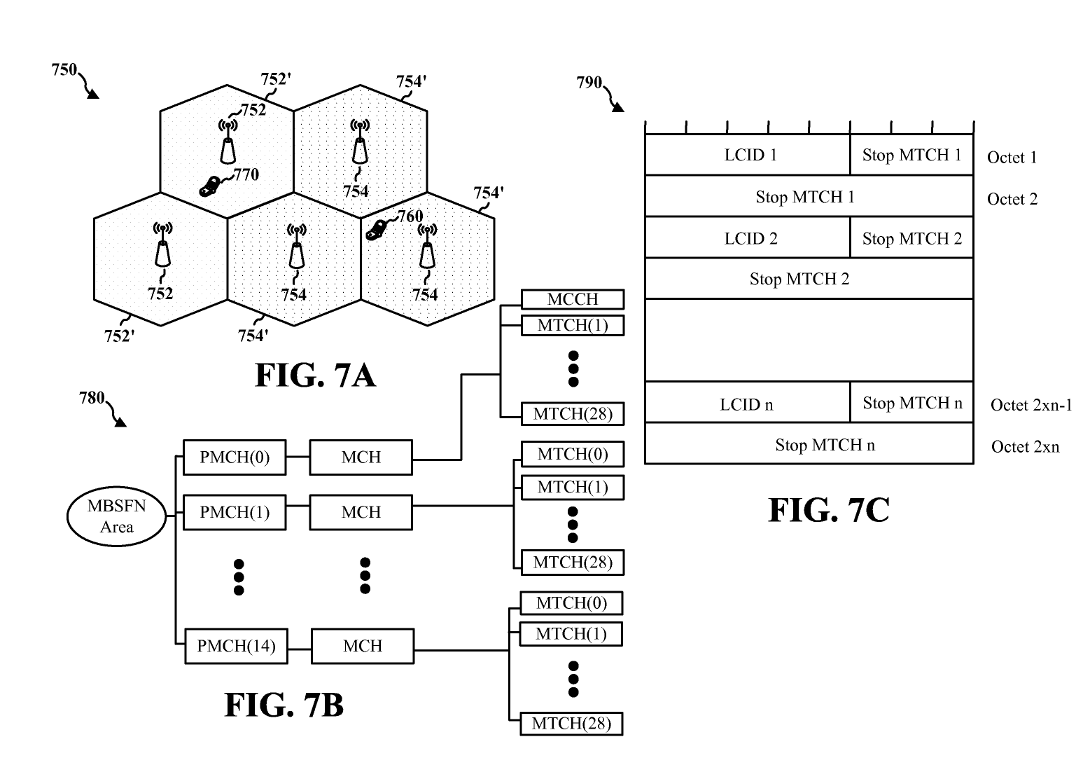

FIG. 7A is a diagram 750 illustrating an example of an evolved MBMS (eMBMS) channel configuration in an MBSFN. The eNBs 752 in cells 752′ may form a first MBSFN area and the eNBs 754 in cells 754′ may form a second MBSFN area. The eNBs 752, 754 may each be associated with other MBSFN areas, for example, up to a total of eight MBSFN areas. A cell within an MBSFN area may be designated a reserved cell. Reserved cells do not provide multicast/broadcast content, but are time-synchronized to the cells 752′, 754′ and may have restricted power on MBSFN resources in order to limit interference to the MBSFN areas. Each eNB in an MBSFN area synchronously transmits the same eMBMS control information and data. Each area may support broadcast, multicast, and unicast services. A unicast service is a service intended for a specific user, e.g., a voice call. A multicast service is a service that may be received by a group of users, e.g., a subscription video service. A broadcast service is a service that may be received by all users, e.g., a news broadcast. Referring to FIG. 7A, the first MBSFN area may support a first eMBMS broadcast service, such as by providing a particular news broadcast to UE 770. The second MBSFN area may support a second eMBMS broadcast service, such as by providing a different news broadcast to UE 760. FIG. 7B is a diagram 780 illustrating an example of an MBSFN area. As shown in FIG. 7B, each MBSFN area supports one or more physical multicast channels (PMCH) (e.g., 15 PMCHs). Each PMCH corresponds to a multicast channel (MCH). Each MCH can multiplex a plurality (e.g., 29) of multicast logical channels. Each MBSFN area may have one multicast control channel (MCCH). As such, one MCH may multiplex one MCCH and a plurality of multicast traffic channels (MTCHs) and the remaining MCHs may multiplex a plurality of MTCHs.

A UE can camp on an LTE cell to discover the availability of eMBMS service access and a corresponding access stratum configuration. Initially, the UE may acquire a system information block (SIB) 13 (SIB13). Subsequently, based on the SIB13, the UE may acquire an MBSFN Area Configuration message on an MCCH. Subsequently, based on the MBSFN Area Configuration message, the UE may acquire an MCH scheduling information (MSI) MAC control element. The SIB13 may include (1) an MBSFN area identifier of each MBSFN area supported by the cell; (2) information for acquiring the MCCH such as an MCCH repetition period (e.g., 32, 64, . . . , 256 frames), an MCCH offset (e.g., 0, 1, . . . , 10 frames), an MCCH modification period (e.g., 512, 1024 frames), a signaling modulation and coding scheme (MCS), subframe allocation information indicating which subframes of the radio frame as indicated by repetition period and offset can transmit MCCH; and (3) an MCCH change notification configuration. There is one MBSFN Area Configuration message for each MBSFN area. The MBSFN Area Configuration message may indicate (1) a temporary mobile group identity (TMGI) and an optional session identifier of each MTCH identified by a logical channel identifier within the PMCH, and (2) allocated resources (i.e., radio frames and subframes) for transmitting each PMCH of the MBSFN area and the allocation period (e.g., 4, 8, . . . , 256 frames) of the allocated resources for all the PMCHs in the area, and (3) an MCH scheduling period (MSP) (e.g., 8, 16, 32, . . . , or 1024 radio frames) over which the MSI MAC control element is transmitted.

FIG. 7C is a diagram 790 illustrating the format of an MSI MAC control element. The MSI MAC control element may be sent once each MSP. The MSI MAC control element may be sent in the first subframe of each scheduling period of the PMCH. The MSI MAC control element can indicate the stop frame and subframe of each MTCH within the PMCH. There may be one MSI per PMCH per MBSFN area. A logical channel identifier (LCID) field (e.g., LCID 1, LCID 2, . . . , LCID n) may indicate a logical channel identifier of the MTCH. A Stop MTCH field (e.g., Stop MTCH 1, Stop MTCH 2, . . . , Stop MTCH n) may indicate the ordinal number of the subframe within the MCH scheduling period counting only the subframes allocated to the MCH, where the corresponding MTCH stops.

The UE (e.g., the UE 102, the UE 650) may utilize a single radio for two radio access technologies (RATs) such as LTE (e.g., single radio LTE or SRLTE) and CDMA. The single radio UE may also utilize a dual subscriber-identity-module dual standby (DSDS) feature where a first subscriber identity module (SIM) card is for one RAT such as LTE and a second SIM card is for another RAT such as a non-LTE RAT. In a situation where the UE utilizes a single radio configuration or a dual SIM (DS) configuration with a single radio, if a non-LTE RAT (e.g., CDMA or GSM) is in an idle mode, the UE utilizes the single radio to receive an MBMS service via LTE and may occasionally tune away briefly from LTE to a non-LTE RAT in order to monitor pages in the non-LTE RAT. Thus, in such a case, the UE utilizes the single radio mostly for receiving the MBMS service in LTE and sometimes utilizes the non-LTE RAT for page monitoring. For example, because the UE utilizes the non-LTE RAT for voice communication and LTE for data communication, when the UE receives the MBMS service via LTE, the UE performs page monitoring in the non-LTE RAT from time to time to monitor for an incoming voice calls via the non-LTE RAT, such that the UE may be able to receive the voice calls.

In eMBMS multimedia streaming, the UE may use a dynamic adaptive streaming over hypertext-transfer-protocol (DASH) protocol to receive video data and audio data via eMBMS. In the multimedia streaming, when a multimedia content is encoded for transmission, an encoder may split the multimedia content into audio data and video data, such that a network (e.g., an eNB) may transmit the audio data and the video data. If the DASH protocol is utilized, for each DASH segment duration, a multimedia content may be encoded into one audio DASH segment and one video DASH segment. For example, if the DASH segment duration is 1 second, 1 second of the multimedia content may be encoded into one audio DASH segment and one video DASH segment. For each DASH segment duration, the network may transmit one audio DASH segment and one video DASH segment. In each DASH segment duration, the audio DASH segment may be transmitted over one MSP whereas the video DASH segment may be transmitted in multiple video segment portions over multiple MSPs. Thus, the network (e.g., an eNB) may transmit video data and audio data in separate DASH segments (e.g., via a non-multiplexed representation), where the DASH segments are pieces of the video data and the audio data. The UE may receive the audio DASH segments and the video DASH segments over eMBMS and combine the received audio and video DASH segments to stream the eMBMS multimedia including audio and video.

The network may send an audio segment (audio DASH segment) before sending a video segment (video DASH segment) in a sequence of MTCH transmission periods, or may send the audio segment at any time during each segment duration (DASH segment duration). In particular, in one configuration, for each segment duration, the network may first transmit an audio segment, and then transmit a video segment. In an alternative configuration, the network may transmit an audio segment at any time during the segment duration. The transmitted audio segment is generally made of one audio object, but in some instances, the transmitted audio segment may include multiple audio objects. For example, the multiple audio objects in the audio segment may be for audio data for different languages respectively. In one example, media content may be encoded in audio segments and video segments separately, and the network may send the encoded media content in audio and video segments. If a segment of the media content has a segment duration of two seconds, it may take the network two seconds to transmit the media content. Generally, transmission of an audio segment takes less bandwidth (e.g., approximately 5% of a bandwidth for a video segment) than transmission of a video segment. An audio segment may be transmitted once during a segment duration, and the audio segment may include audio data for the entire segment duration. Thus, for example, if the UE misses (e.g., fails to receive) a portion of data, but if the missing portion of data corresponds with the audio segment, then the audio for the entire segment duration can be lost. Hence, in such an example, the UE may not play any audio for the entire segment duration corresponding to the missing audio segment.

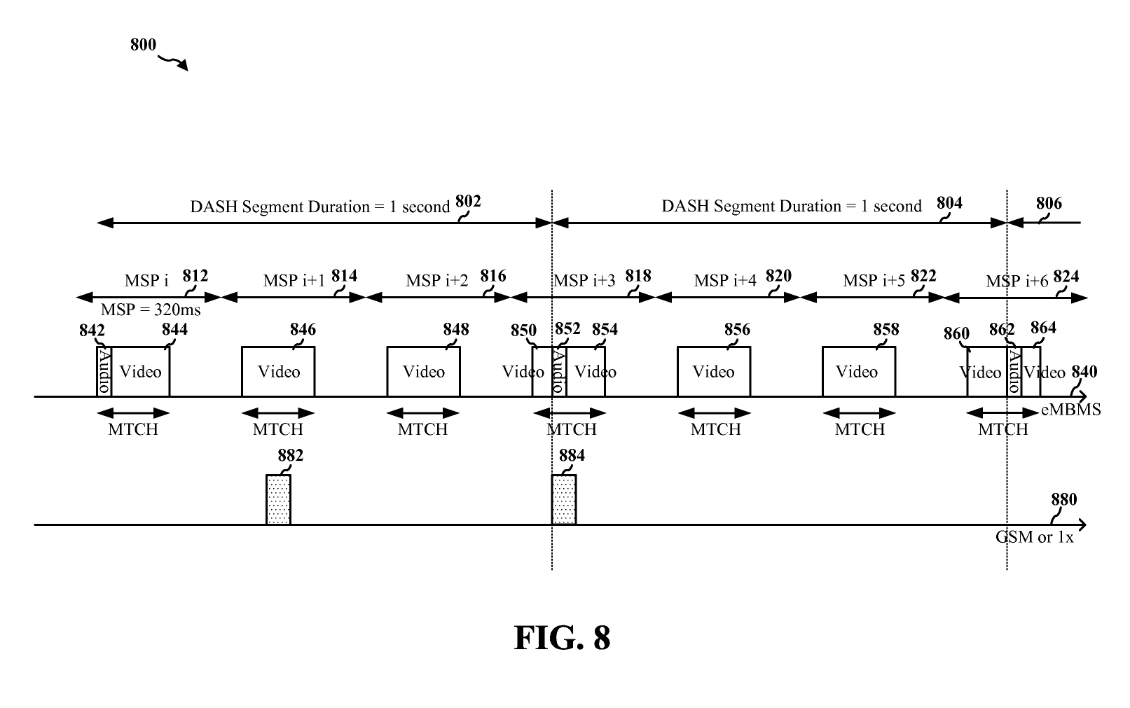

FIG. 8 is a first example diagram 800 illustrating communication of DASH segments over one RAT and paging via another RAT. The example diagram 800 shows communication of DASH segments for eMBMS content via LTE and paging via GSM, over two DASH segment durations (a first DASH segment duration 802 and a second DASH segment duration 804), and continuing through a third DASH segment duration 806, where each DASH segment duration is 1 second. Generally, within one DASH segment duration, one DASH segment may be transmitted over multiple MSPs, and another DASH segment may be transmitted over one MSP. For example, within one DASH segment duration, a video segment (video DASH segment) may be transmitted over multiple MSPs, and an audio segment (audio DASH segment) may be transmitted over one MSP. As illustrated in FIG. 8, a video segment may be transmitted in multiple video segment portions over multiple MSPs. The video DASH segment and the audio DASH segment may be transmitted at a specified data rate (e.g., 1 megabit per second).

In FIG. 8, eMBMS time line 840 shows audio and video segments transmitted over multiple DASH segment durations. During the first DASH segment duration 802, a first network (e.g., LTE network) transmits an audio DASH segment including an audio segment 842 and a video DASH segment including video segment portions 844, 846, 848, and 850. The first network transmits the audio segment 842 and the video segment portions 844, 846, 848, and 850 at a specific data rate (e.g., 1 megabit per second), such that the first network may finish transmitting the audio DASH segment including the audio segment 842 and the video DASH segment including the video segment portions 844, 846, 848, and 850 within the first DASH segment duration 802. During the second DASH segment duration 804, the first network transmits an audio DASH segment including an audio segment 852 and a video DASH segment including video segment portions 854, 856, 858, and 860. The first network transmits the audio segment 852 and the video segment portions 854, 856, 858, and 860 at a specific data rate (e.g., 1 megabit per second), such that the network may finish transmitting the audio DASH segment including an audio segment 852 and the video DASH segment including video segment portions 854, 856, 858, and 860 within the second DASH segment duration 804.

When the first network transmits an eMBMS service to the UE, the first network may transmit the audio segment 842 and the video segment portion 844 during MSP i 812. As illustrated, the time duration of the audio segment 842 is smaller than the time duration of the video DASH segment which includes the video segment portions 844, 846, 848, and 850 in the first DASH segment duration 802. For the rest of the first DASH segment duration 802, the first network transmits the video segment portion 846 during MSP i+1 814, transmits the video segment portion 848 during MSP i+2 816, and then transmits the video segment portion 850 during an earlier portion of MSP i+3 818. As the second DASH segment duration 804 begins, the first network transmits an audio segment 852 and a video segment portion 854 during MSP i+3 818. As illustrated, the time duration of the audio segment 852 is smaller than the time duration of the video DASH segment including the video segment portions 854, 856, 858, and 860 in the second DASH segment duration 804. For the rest of the second DASH segment duration 804, the first network transmits a video segment portion 856 during MSP i+4 820, and transmits a video segment portion 858 during MSP i+5 822, and transmits a video segment portion 860 during an earlier part of MSP i+6 824. As the third DASH segment duration 806 begins, the first network transmits an audio segment 862 and a video segment portion 864 during MSP i+6 824. Each of the MSP may have duration of 320 ms. In the example diagram 800, the first data transmitted to the UE in each DASH segment duration is an audio segment, such as the audio segment 842 and the audio segment 852.

A second network (e.g., a GSM network or a 1× network) may transmit a page via GSM or 1× (e.g., CDMA), respectively. In the example diagram 800, the GSM/1× time line 880 shows pages being transmitted over time. In particular, the second network sends a page 882 and a page 884 via GSM or 1×. The UE tunes away from LTE to GSM or 1× briefly in order to receive the page 882 and the page 884. Thus, when the UE tunes away from LTE to receive the page 882, the UE may not receive a corresponding portion of the video segment portion 846. When the UE tunes away from LTE to receive the page 884, the UE may receive neither the audio segment 852, nor the portion of the video segment portion 854 corresponding to the time duration (or overlapping the duration) of the page 884. If the UE does not receive a portion of a video segment, the UE may correct errors caused by not receiving the entire video segment, in order to recover at least some of the missing portion of the video segment by performing an error correction procedure such as a forward error correction (FEC) on the partially received video segment. Such recovery of the missing data of the video segment may be based at least in part on other portions of the video segment that are successfully received. However, if the UE fails to receive the entire audio segment (e.g., the audio segment 852), then an error correction procedure may not be able to correct or recover the lost audio data. Because the time duration of the audio segment is generally small (e.g., 10-20 ms), the entire audio segment may be lost due to the tune away to GSM or another RAT (e.g., 1×).

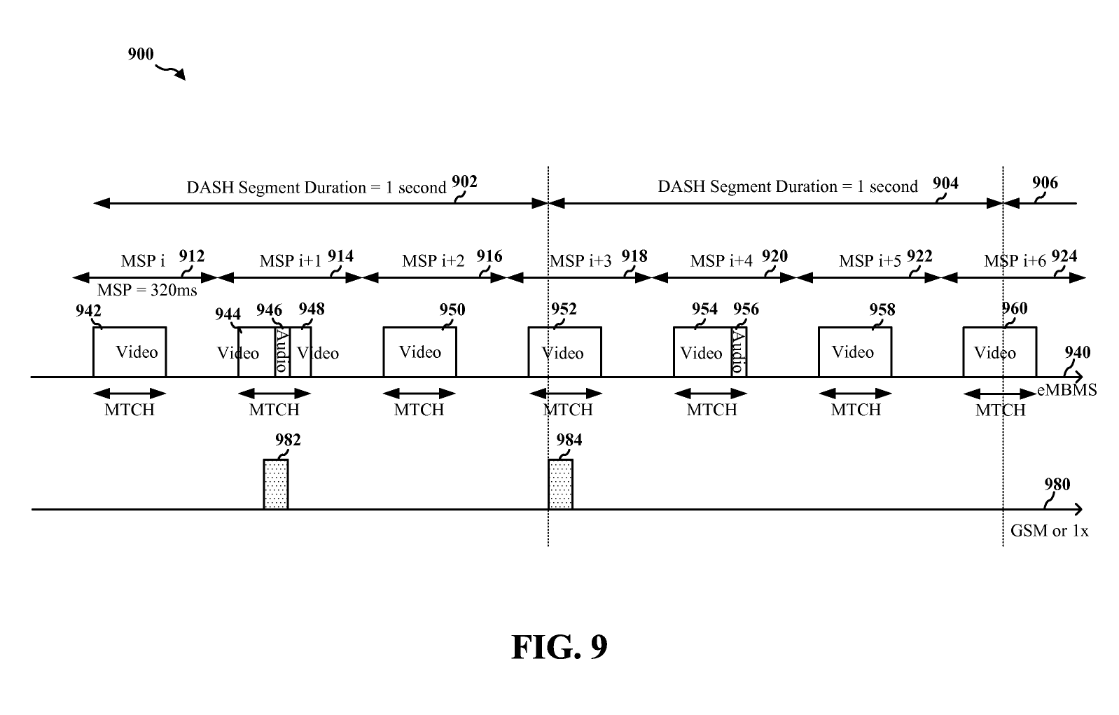

FIG. 9 is a second example diagram 900 illustrating communication of DASH segments over one RAT and paging via another RAT. The example diagram 900 shows communication of DASH segments for eMBMS content via LTE and also shows paging via GSM, over two DASH segment durations (a first DASH segment duration 902 and a second DASH segment duration 904), and continuing through a third DASH segment duration 906, where each DASH segment duration is 1 second. Generally, within one DASH segment duration, one DASH segment may be transmitted over multiple MSPs, and another DASH segment may be transmitted over one MSP. For example, within one DASH segment duration, a video segment (video DASH segment) may be transmitted over multiple MSPs, and an audio segment (audio DASH segment) may be transmitted over one MSP.

In the second example diagram 900 of FIG. 9, an eMBMS time line 940 shows audio and video segments transmitted over multiple DASH segment durations. Unlike the first example diagram 800 of FIG. 8, in the second example diagram 900 of FIG. 9, a corresponding audio segment is not always transmitted at the beginning of each DASH segment duration, but is rather transmitted sometime during each DASH segment duration. During the first DASH segment duration 902, a first network (e.g., LTE network) transmits an audio DASH segment including an audio segment 946 and a video DASH segment including video segment portions 942, 944, 948, 950, and a first portion of a video segment portion 952. The first network transmits the audio segment 946, the video segment portions 942, 944, 948, 950, and the first portion of a video segment portion 952 at a specific data rate (e.g., 1 megabit per second), such that the first network may finish transmitting the audio DASH segment and the video DASH segment including within the first DASH segment duration 802. During the second DASH segment duration 904, the first network transmits an audio DASH segment including an audio segment 956 and a video DASH segment including a second portion of a video segment portion 952 and video segment portions 954, 958, and a first portion of a video segment portion 960. The first network transmits the audio segment 956, the second portion of a video segment portion 952, the video segment portions 954, 958, and the first portion of the video segment portion 960 at a specific data rate (e.g., 1 megabit per second), such that the first network may finish transmitting the audio DASH segment and the video DASH segment including within the second DASH segment duration 804.

When the first network transmits an eMBMS service to the UE, the first network transmits the video segment portion 942 during MSP i 912. During MSP i+1 914, the first network transmits the video segment portion 944, the audio segment 946, and the video segment portion 948. As illustrated, the duration of the audio segment 946 is smaller than the duration of the video DASH segment including the video segment portions 942, 944, 948, and 950, and a part of the video segment portion 952 in the first DASH segment duration 902. During MSP i+2 916, the first network transmits the video segment portion 950. During MSP i+3 918, the first network transmits the first portion of the video segment portion 952 at the end of the first DASH segment duration 902 and the second portion of the video segment portion 952 at the beginning of the second DASH segment duration 904. During MSP i+4 920, the first network transmits the video segment portion 954 and the audio segment 956. As illustrated, the audio segment 956 is smaller than the video DASH segment including a part of the video segment portion 954, the video segment portion 958, and a part of the video segment portion 960 in the second DASH segment duration 904. During MSP i+5 922, the first network transmits a DASH segment including a video segment portion 958. During MSP i+6 924, the first network transmits the first portion of the video segment portion 960 at the end of the second DASH segment duration 904 and the second portion of the video segment portion 960 at the beginning of the third DASH segment duration 906. Each of the MSP may have duration of 320 ms. Some portion of each DASH segment may be transmitted during a corresponding MTCH period.

A second network (e.g., GSM network) may transmit a page via GSM or another RAT (e.g., 1×). In the example diagram 900, the GSM/1× time line 980 shows pages being transmitted over time. In particular, the second network sends a page 982 and a page 984 via GSM or 1×. The UE tunes away from LTE to GSM or 1× briefly in order to receive the page 982 and the page 984. Thus, when the UE tunes away from LTE to receive the page 982, the UE may not receive the audio segment 946 and a portion of the video segment portion 944 that overlaps with the timing of the page 982. When the UE tunes away from LTE to receive the page 984, the UE may not receive a portion of the video segment portion 952 that overlaps with the timing of the page 984. If the UE does not receive a portion of a video segment, the UE may correct errors caused by not receiving the entire video segment to recover at least some of the lost video segment by performing an error correction procedure such as a forward error correction. Such recovery of the missing portion of the video segment may be based at least in part on other portions of the video segment that are successfully received. However, if the UE fails to receive an audio segment (e.g., the audio segment 946), then an error correction procedure may not be able to correct or recover sufficient portion of the lost audio data. Because the audio segment is generally very small (e.g., 10-20 ms), an entire portion of the audio segment may be lost due to the tune away to GSM or another RAT (e.g., 1×).

According to an aspect of the disclosure, because the first network (e.g., LTE network) transmits an audio segment in a very short period of time in each DASH segment duration, refraining by the UE from tuning away (tuning away from LTE to GSM/1×) during a time period when an audio segment is transmitted may be desirable, such that the UE will successfully receive the audio segment. By refraining from tuning away during transmission of an audio segment, the UE may be able to receive the audio segment even when scheduling of a GSM/1× page monitoring overlaps with transmission of the audio segment. In an aspect, the UE may refrain from tuning away during a time period when an audio segment is transmitted if the UE determines that page monitoring via GSM/1× occurs during the transmission of the audio segment. In another aspect, the UE may refrain from tuning away during every time period when an audio segment is transmitted, regardless of whether paging via GSM/1× may occur during some audio segment transmissions.

In order to refrain from tuning away during transmission of an audio segment, the UE may determine whether a data segment is an audio segment and may determine a transmission time of the audio segment, according to various approaches. In particular, the UE may determine the transmission time of a data segment, and determine whether the data segment is an audio segment.

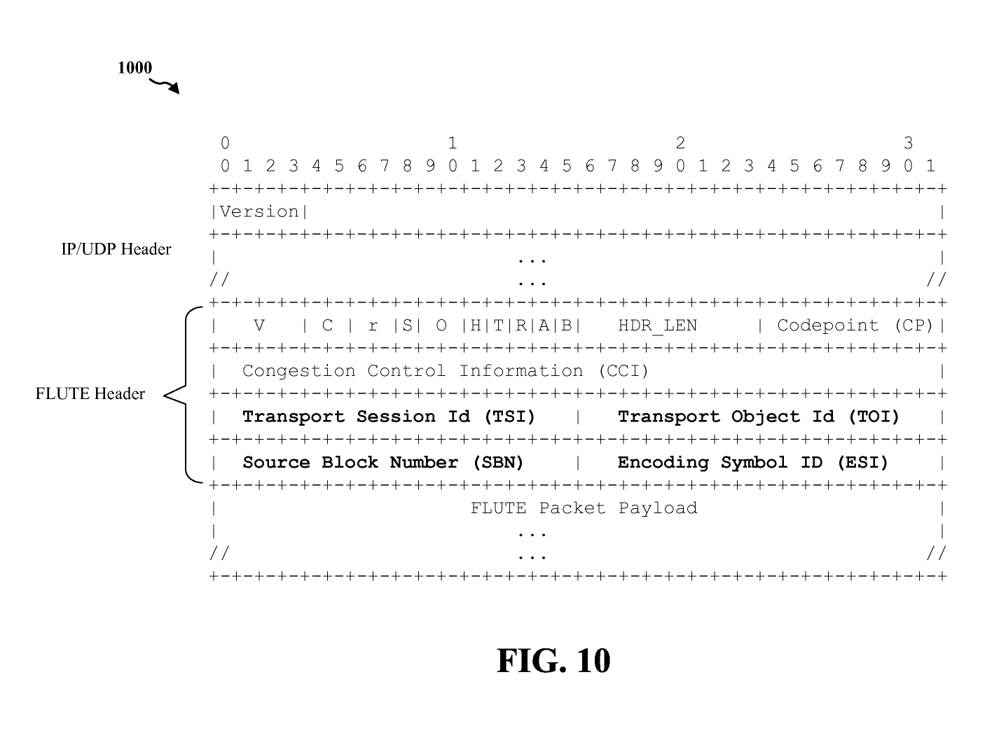

In an aspect, the UE may determine the transmission time of a data segment based on a symbol (e.g., a forward error correction symbol) received by the UE. FIG. 10 illustrates an example structure 1000 of an IP packet. An audio segment and a video segment include multiple IP packets. In general, multiple IP packets (e.g., 30 IP packets) are transmitted per MSP. The IP packet in FIG. 10 may be a file delivery over unidirectional transport (FLUTE) packet delivered over IP. Audio segments and video segments may be transmitted to the UE in IP packets. As illustrated in FIG. 10, an IP packet includes an IP/UDP packet header and a FLUTE header, and the FLUTE header includes a transport session identifier (TSI), a transport object identifier (TOI), a source block number (SBN), and an encoding symbol identifier (ESI). The UE may recognize each symbol based on the SBN and the ESI.

In one configuration, an audio segment is a first media segment transmitted to the UE in each DASH segment duration. In such a configuration, the UE may determine, based on information in an IP packet, a first symbol received by the UE. Each IP packet generally includes multiple symbols. For example, if each IP packet includes 10 symbols where each symbol may have around one hundred bytes, an IP packet may include symbols 0 to 9, and may include ESI=0 to represent the first symbol of the IP packet. In such an example, a subsequent IP packet may include symbols 10 to 19 and may include ESI=10 to represent the first symbol of the subsequent IP packet. For example, if the IP packet indicates SBN=0 and ESI=0 (and TOI>0, as TOI=0 represents a file delivery table (FDT) packet), the UE determines that a symbol in the IP packet is a first symbol received by the UE in a DASH segment duration, and may determine that such symbol corresponds to an audio segment as described below. Further, if the UE receives the IP packet and the UE determines that SBN=0 and ESI=0 based on the IP packet, then the UE records the time the UE receives the IP packet. When the IP packet with SBN=0 and ESI=0 is an audio segment, the recorded time for the IP packet is t0 which represents the time when an audio segment is first received at UE. In this configuration when an audio segment is transmitted first in each DASH segment duration, t0 represents the start time of the transmission of the first audio segment and corresponds to the time of receipt of the IP packet with SBN=0 and ESI=0.

Once the UE determines the time t0, the UE may estimate the start time of a future audio packet transmission by adding an appropriate multiple of the DASH segment duration to the determined time t0. Thus, an expected start time tₙ of a later audio packet transmission is estimated by tₙ=t0+DASH segment duration*n, where n is an integer number representing the nth+1 audio packet. At each tₙ corresponding to a different n value, the UE refrains from tuning away for a certain duration. For example, a segment duration timer initially starts running after t0 for a DASH segment duration, and when the segment duration timer expires at t=t0+DASH segment duration, the UE refrains from tuning away for a certain duration around this time because an audio segment transmission is expected around this time. Subsequently, a segment duration timer starts running after t0+DASH segment duration, and when the segment duration timer expires at t=t0+DASH segment duration*2, the UE refrains from tuning away for a certain duration around this time because another audio segment transmission is expected around this time. It is noted that the start time of an audio segment may be re-synchronized occasionally by detecting an IP packet having a first symbol (e.g., an IP packet with SNB=0 and ESI=0) with a corresponding object size less than a threshold Th.

In an alternative configuration, an audio segment may not be a first media segment transmitted to the UE in each DASH segment duration, but may rather be a media segment transmitted to the UE sometime during each DASH segment duration. In the alternative configuration, the UE determines whether a segment is an audio segment or a video segment, and determines a time t0 at which the first audio segment is received. Once the UE determines the time t0, the UE may estimate start times of future audio packet transmissions by adding a multiple of a DASH segment duration to t0 (i.e., time of later audio packet transmission tₐ=t0+DASH segment duration*n, where n is an integer number). At or around each tₐ corresponding to a different n value, the UE refrains from tuning away for a certain duration.

The UE may determine whether a received data segment corresponds to an audio segment or a video segment based on the TSI and/or TOI. In one example, the TOI values may be utilized such that the UE may determine based on the TOI whether a data segment is an audio segment or video segment. In such an example, the TOI value for an audio segment may be an odd number (e.g., 1, 3, 5, etc.), and the TOI value for a video segment may be an even number (e.g., 2, 4, 6, etc.), while a TSI value may be a set number (e.g., TSI=0). In another example, the TSI value may be utilized such that the UE may determine whether a data segment is an audio segment or video segment based on the TSI. In such an example, one TSI value (e.g., TSI=0) may be used for audio segments, and another TSI value (e.g., TSI=1) may be used for video segments. Thus, for TSI=0, the TOI=1, 2, 3, 4, etc. may represent audio segments, and for TSI=1, the TOI=1, 2, 3, 4, etc. may represent video segments. It is noted that TOI=0 is generally reserved for communication of indicate that an object with TOI=0 includes a FDT, where the FDT includes information about object(s) to be transmitted within a file delivery session.

In another aspect, the UE may determine whether a received object corresponds to an audio segment or a video segment based on a size of the received object. For example, the UE may determine the size of the received object based on information provided in a FDT (e.g., a FLUTE FDT). For example, if an object corresponding to a certain TSI value and a certain TOI value has an object size that is less than a threshold (the object size<Th), the UE determines that such object corresponds to an audio segment. If the object size is greater than or equal to the threshold Th, the UE may determine that such object corresponds to a video segment. The threshold Th may vary depending on a DASH segment duration and/or a size of an object. In an aspect, if the DASH segment duration is longer and/or the size of an object is larger, the threshold Th is larger. If the DASH segment duration is longer, the size of an audio object (and a video object) is generally larger. For example, if the DASH segment duration is 1 second, the size of an audio object may be approximately 40 kbits, and if the DASH segment duration is 2 second, the size of an audio object may be approximately 80 kbits. Thus, if the DASH segment duration is 1 second, the threshold Th may be 40 kbits, and if the DASH segment duration is longer (e.g., 2 seconds), the threshold Th may be larger (e.g., 80 kbits). In another aspect, the UE may determine whether a received object corresponds to an audio segment or a video segment based on a file name of a received object, where the file name is included in the FDT. For example, a file name format may be different for an audio segment and for a video segment. For example, if an object corresponding to a certain TSI value and a certain TOI value has a file name indicating an audio segment (e.g., a file name ending with “aac”), the UE determines that such object corresponds to an audio segment. It is noted that the TSI value and the TOI value may be provided in the FDT.

The UE may refrain from tuning away at least during a transmission of an audio segment. In an aspect, the UE may refrain from tuning away some time before a start of the transmission of an audio segment. The UE may refrain from tuning away at an end of the transmission of the audio segment or may continue to refrain from tuning away for some time after the end of the transmission of the audio segment. For example, the UE may refrain from tuning away for the time interval [t−d, t+D], where t is an expected start time of an audio segment transmission, d is a first duration, and D is a second duration. The UE may determine the first duration d based on an expected error. The UE may determine the first duration d based on the second duration D, where the first duration d is a percentage of the second duration D. For example, the value of the first duration d may be 20% of the value of the second duration D. The second duration D is set to be large enough to cover at least the duration of audio segment transmission time. In an aspect, the UE may determine the second duration D based on an object size, a data rate of audio transmission and/or a DASH segment duration. For example, if the object size is 80 kbits, and the DASH segment duration of 2 seconds, and the data rate is 1 megabit/sec, then the object size 80 kbits is divided by 1 megabit/sec to determine D=80 msec.

In one aspect, the second duration D may be equal to the duration of the audio transmission, and thus the UE may stop refraining from tuning away when the audio transmission ends. In another aspect, the second duration D may be an absolute time value or a time running only during an MTCH transmission interval. If the second duration D is an absolute time value, the UE refrains from tuning away for the second duration D. For example, if the second duration D is 80 msec, and the MTCH transmission interval is 50 msec, the UE may refrain from tuning away during a corresponding MTCH transmission for 50 msec, and continue to refrain from tuning away for another 30 msec after the corresponding MTCH transmission. If the second duration D is time running only during the MTCH transmission interval, the UE refrains tuning away for only during the MTCH transmission interval even if the second duration D may be larger than the MTCH transmission interval. For example, if the second duration D is 80 msec, and the MTCH transmission interval is 50 msec, the UE may refrain from tuning away during a first MTCH for 50 msec (the entire MTCH), and then refrain from tuning away during a second (subsequent) MTCH for 30 msec, thus refraining from tuning away for the total of 80 msec over two MTCH intervals. In another aspect, the UE may refrain from tuning away for an entire MSP in which a transmission of an audio object occurs.

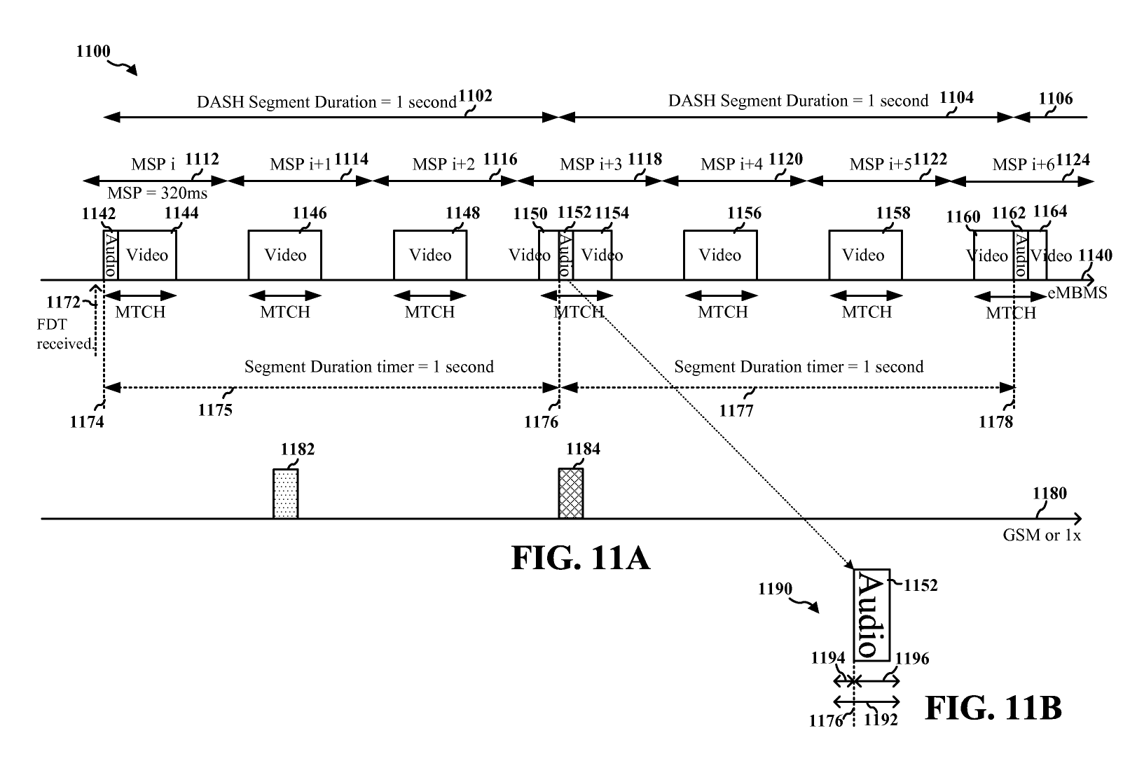

FIG. 11A is a first example diagram 1100 illustrating communication of DASH segments over one RAT, paging via another RAT, and refraining from tuning away, according to an aspect of the disclosure. The example diagram 1100 shows communication of DASH segments for eMBMS content via LTE and also shows paging via GSM, over two DASH segment durations (a first DASH segment duration 1102 and a second DASH segment duration 1104), and continuing through a third DASH segment duration 1106, where each DASH segment duration is 1 second. In the first example diagram 1100 of FIG. 11A, an eMBMS time line 1140 shows audio and video DASH segments transmitted over multiple DASH segment durations. An audio segment 1142 and a video segment portion 1144 in MSP i 1112, a video segment portion 1146 in MSP i+1 1114, a video segment portion 1148 in MSP i+2 1116, a video segment portion 1150, an audio segment 1152, and a video segment portion 1154 in MSP i+3 1118, a video segment portion 1156 in MSP i+4 1120, a video segment portion 1158 in MSP i+5 1122, and a video segment portion 1160, an audio segment 1162, a video segment portion 1164 in MSP i+6 1124 are respectively similar to the audio segment 842 and the video segment portion 844 in MSP i 812, the video segment portion 846 in MSP i+1 814, the video segment portion 848 in MSP i+2 816, the video segment portion 850, the audio segment 852, and the video segment portion 854 in MSP i+3 818, the video segment portion 856 in MSP i+4 820, the video segment portion 858 in MSP i+5 822, and the video segment portion 860, the audio segment 862, the video segment portion 864 in MSP i+6 824 of FIG. 8, and thus explanations thereto is omitted for brevity.

At 1172, the UE receives an FDT right before receiving the audio segment 1142. The FDT may include information about the size of an object corresponding to the audio segment 1142 and corresponding to a certain TSI value and a certain TOI value. In an aspect, the UE may determine that the audio segment 1142 is an audio segment based on the size of the object indicated by the FDT (e.g., the size of the object<Th). In another aspect, the UE may determine that the audio segment 1142 is an audio segment based on a TSI and/or TOI associated with the audio segment 1142. The UE may determine that t0 is at 1174 when SBN=0 and ESI=0. Thus, the audio segment 1142 received at the UE occurs at 1174 or t0. Therefore, the UE may estimate that the expected start time 1176 of a second audio segment transmission (e.g., transmission of the audio segment 1152) is t0+DASH segment duration, or t0+1 second in this example. The UE may estimate that the expected start time 1178 of a third audio segment transmission (e.g., transmission of the audio segment 1162) is t0+DASH segment duration*2, or t0+2 seconds in this example. In the example diagram 1100, the GSM/1× time line 1180 shows pages being transmitted over time. At 1174, there is no paging via GSM or 1×, and the UE receives the audio segment 1142. When a page 1182 is transmitted, the UE tunes away to receive the page 1182 via GSM or 1×, and thus does not receive a corresponding portion of the video segment portion 1146. However, because a large portion of the video DASH segment is received at the UE over the first DASH segment duration 1102, the UE may perform error correction to recover at least a part of the missed data of the video DASH segment (e.g., the missing portion of the video segment portion 1146). At 1176, around the time when the segment duration timer 1175 expires, the UE may refrain from tuning away for a duration that is at least as long as the duration of the transmission of the audio segment 1152. It is noted that the transmission of the audio segment 1152 overlaps at least in part with transmission of the page 1184 via GSM or 1×. During the transmission of the audio segment 1152, because the UE refrains from tuning away, the UE does not receive the page 1184 via GSM or 1×, but receives the audio segment 1152. At 1178, when the segment duration timer 1177 expires, there is no paging via GSM or 1×, and the UE receives the audio segment 1162.

FIG. 11B is a diagram 1190 illustrating an example tune-away duration in relation to the first example diagram 1100 of FIG. 11A. In the example illustrated in FIG. 11A, the UE may refrain from tuning away from LTE to another RAT around the time of the transmission of the audio segment 1152. For example, as discussed supra, the UE may refrain from tuning away for a tune-away duration [t−d, t+D], where t is an expected start time of an audio segment transmission, d is a first duration, and D is a second duration. Thus, in the example illustrated in FIG. 11A and FIG. 11B, the UE may refrain from tuning away for the tune-away duration 1192, where the expected start time of transmission of the audio segment 1152 is at 1176, and the first duration d is represented by 1194 and the second duration D is represented by 1196.

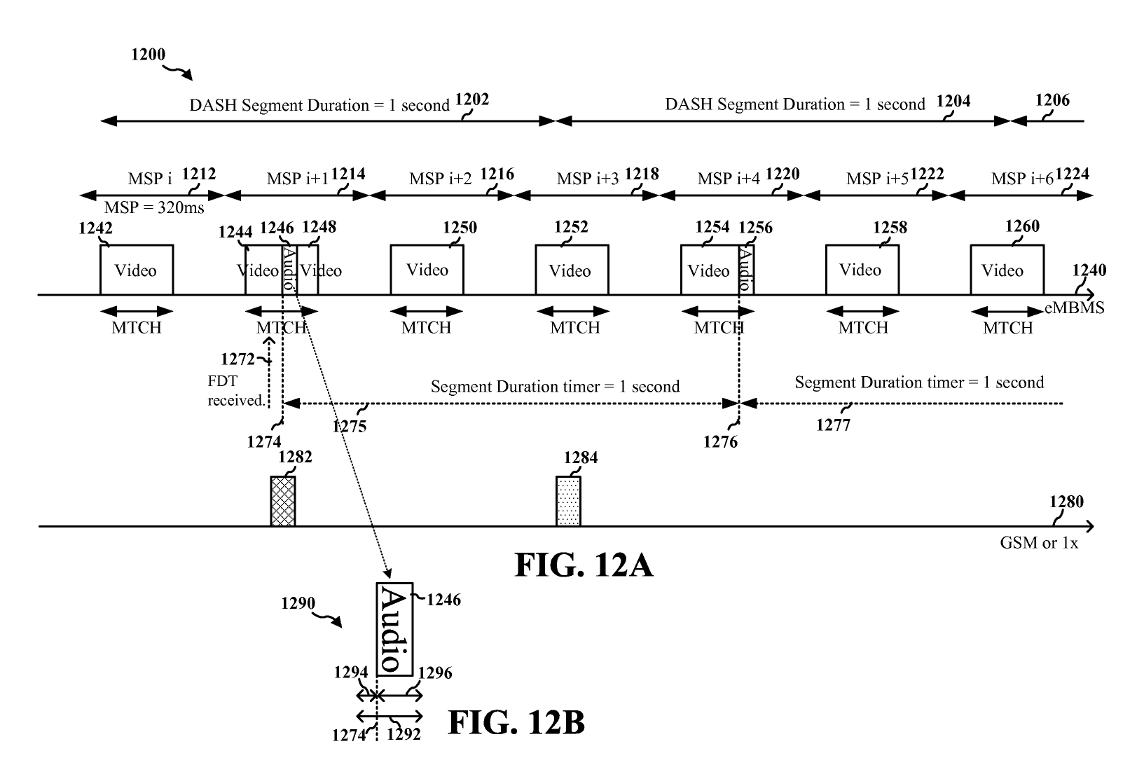

FIG. 12A is a second example diagram 1200 illustrating communication of DASH segments over one RAT, paging via another RAT, and refraining from tuning away, according to an aspect of the disclosure. The example diagram 1200 shows communication of DASH segments for eMBMS content via LTE and paging via GSM, over two DASH segment durations (a first DASH segment duration 1202 and a second DASH segment duration 1204), and continuing through a third DASH segment duration 1206, where each DASH segment duration is 1 second. In the second example diagram 1200 of FIG. 12A, an eMBMS time line 1240 shows audio and video DASH segments transmitted over multiple DASH segment durations. A video segment portion 1242 in MSP i 1212, a video segment portion 1244, an audio segment 1246, and a video segment portion 1248 in MSP i+1 1214, a video segment portion 1250 in MSP i+2 1216, a video segment portion 1252 in MSP i+3 1218, a video segment portion 1254 and an audio segment 1256 in MSP i+4 1220, a video segment portion 1258 in MSP i+5 1222, and a video segment portion 1260 in MSP i+6 1224 are respectively similar to the video segment portion 942 in MSP i 912, the video segment portion 944, the audio segment 946, and the video segment portion 948 in MSP i+1 914, the video segment portion 950 in MSP i+2 916, the video segment portion 952 in MSP i+3 918, the video segment portion 954 and the audio segment 956 in MSP i+4 920, the video segment portion 958 in MSP i+5 922, and the video segment portion 960 in MSP i+6 924 of FIG. 9, and thus explanations thereto is omitted for brevity.

At 1272, the UE receives an FDT right before receiving the audio segment 1246. The FDT may include information about the size of an object corresponding to the audio segment 1246 and corresponding to a certain TSI value and a certain TOI value. In an aspect, the UE may determine that the audio segment 1246 is an audio segment based on the size of the object indicated by the FDT (e.g., the size of the object<Th). In another aspect, the UE may determine that the audio segment 1246 is an audio segment based on a TSI and/or TOI associated with the audio segment 1246. The UE may determine t0 occurs at 1274 by determining that the audio segment 1246 starts at 1274. Thus, the audio segment 1246 received at the UE is at t0 or 1274. Therefore, the UE may estimate that the start time 1276 of a second audio segment transmission (e.g., transmission of the audio segment 1256) is t0+DASH segment duration or t0+1 second in this example. At 1274, the UE may refrain from tuning away for a duration that is at least as long as the duration of the transmission of the audio segment 1246. At 1274, the UE may refrain from tuning away for a duration that is at least as long as the duration of the transmission of the audio segment 1246. In the example diagram 1200, the GSM/1× time line 1280 shows pages being transmitted over time. It is noted that the transmission of the audio segment 1246 overlaps at least in part with transmission of the page 1282 via GSM or 1×. During the transmission of the audio segment 1246, because the UE refrains from tuning away, the UE does not receive the page 1282 via GSM or 1×, but receives the audio segment 1246. When a page 1284 is transmitted, the UE tunes away to receive the page 1284 via GSM or 1×, and thus does not receive a corresponding portion of the video segment portion 1252. However, because a large portion of the video DASH segment is received at the UE over the second DASH segment duration 1204, the UE may perform error correction to recover at least a part of the missed data of the video DASH segment (e.g., the missing portion of the video segment portion 1252). At 1276, when the segment duration timer 1275 expires, there is no paging via GSM or 1×, and the UE receives the audio segment 1256. At 1276, the segment duration timer 1277 starts running

FIG. 12B is a diagram 1290 illustrating an example tune-away duration in relation to the second example diagram 1200 of FIG. 12A. In the example illustrated in FIG. 12A, the UE may refrain from tuning away from LTE to another RAT around the time of the transmission of the audio segment 1246. For example, as discussed supra, the UE may refrain from tuning away for a tune-away duration [t−d, t+D], where t is an expected start time of an audio segment transmission, d is a first duration, and D is a second duration. Thus, in the example illustrated in FIG. 12A, the UE may refrain from tuning away for the tune-away duration 1292, where the expected start time of transmission of the audio segment 1246 is at 1274, and the first duration d is represented by 1294 and the second duration D is represented by 1296.

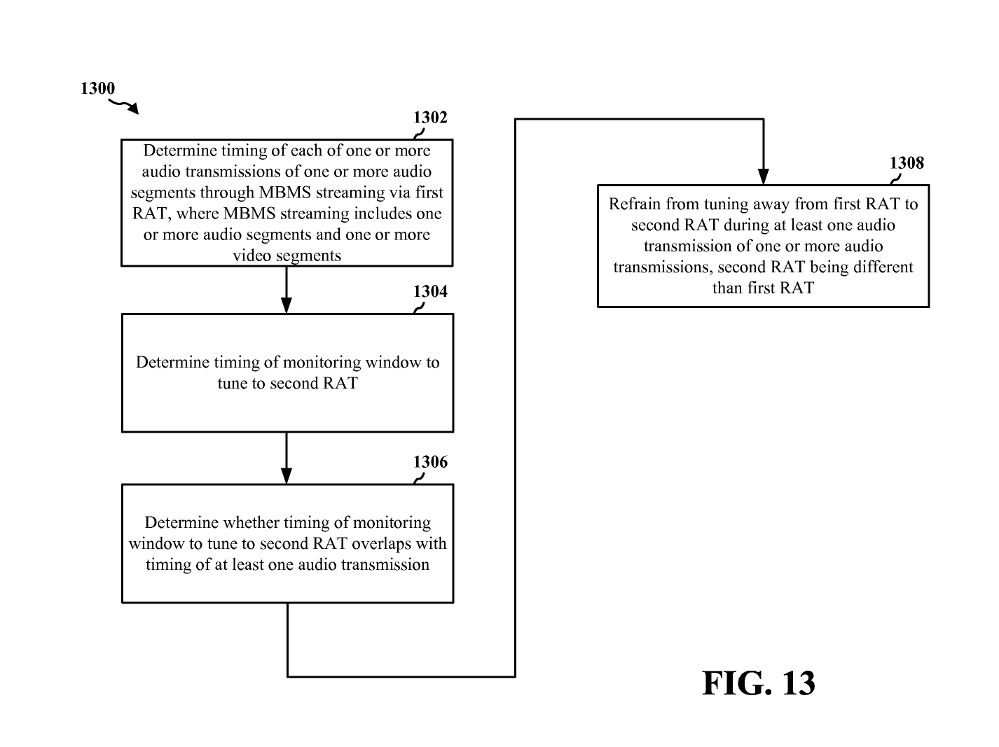

FIG. 13 is a flow chart 1300 of a method of wireless communication. The method may be performed by a UE (e.g., the UE 102, the apparatus 1402/1402′). At 1302, the UE determines a timing of each of one or more audio transmissions of one or more audio segments through MBMS streaming via a first RAT, where the MBMS streaming includes the one or more audio segments and one or more video segments. At 1304, the UE determines a timing of a monitoring window to tune to the second RAT. At 1306, the UE determines whether the timing of the monitoring window to tune to the second RAT overlaps with the timing of the at least one audio transmission. At 1308, the UE refrains from tuning away from the first RAT to a second RAT during at least one audio transmission of the one or more audio transmissions, the second RAT being different than the first RAT. In an aspect, the UE refrains from tuning away from the first RAT to the second RAT when the timing of the monitoring window to tune to the second RAT overlaps with the timing of the at least one audio transmission. In an aspect, the monitoring window is a paging window.

For example, as discussed supra, by refraining from tuning away during transmission of an audio segment, the UE may be able to receive the audio segment even when scheduling of a GSM/1× page monitoring overlaps with transmission of the audio segment. For example, as discussed supra, the UE may refrain from tuning away during a time period when an audio segment is transmitted if the UE determines that page monitoring via GSM/1× occurs during the transmission of the audio segment.

In an aspect, the UE may determine the timing of each of the one or more audio transmissions by determining a start time of a transmission of a data segment based on a FLUTE header of an IP packet, and determining that the data segment is an audio segment. In an aspect, the start time of the transmission of the data segment is determined based on an ESI in the FLUTE header. In such an aspect, the start time of the transmission of the data segment is determined further based on an SBN in the FLUTE header. For example, as discussed supra, if the IP packet indicates SBN=0 and ESI=0 (and TOI>0, as TOI=0 represents the FDT packet), the UE determines that a symbol in the IP packet is a first symbol received by the UE in a DASH segment duration, and may determine whether such symbol corresponds to an audio segment. In an aspect, the FLUTE header includes at least one of a TSI or a TOI, and the data segment is determined to be an audio segment based on the at least one of the TSI or the TOI. In one example, as discussed supra, the TOI values may be utilized such that the UE may determine based on the TOI whether a data segment is an audio segment or video segment. In such an example, as discussed supra, the TOI value for an audio segment may be an odd number (e.g., 1, 3, 5, etc.), and the TOI value for a video segment may be an even number (e.g., 2, 4, 6, etc.), while a TSI value may be a set number (e.g., TSI>0). In another example, as discussed supra, the TSI value may be utilized such that the UE may determine whether a data segment is an audio segment or video segment based on the TSI. In such an example, as discussed supra, one TSI value (e.g., TSI=0) may be used for audio segments, and another TSI value (e.g., TSI=1) may be used for video segments.

In another aspect, the UE may further receive at least one FDT associated with the at least one audio transmission, where the data segment is determined to be an audio segment based on information included in the at least one FDT. In such an aspect, the information included in the at least one FDT comprises a file size of each of the one or more audio segments, and the data segment is determined to be an audio segment based on each file size in the at least one FDT. For example, as discussed supra, the UE may determine the size of the received object based on information provided in a FDT (e.g., a FLUTE FDT). For example, as discussed supra, if an object corresponding to a certain TSI value and a certain TOI value has an object size that is less than a threshold (the object size<Th), the UE determines that such object corresponds to an audio segment. In an aspect, the information included in the at least one FDT comprises a file name of each of the one or more audio segments, and the data segment is determined to be an audio segment based on each file name in the at least one FDT. For example, as discussed supra, the UE may determine whether a received object corresponds to an audio segment or a video segment based on a file name of a received object, where the file name is included in the FDT. For example, as discussed supra, if an object corresponding to a certain TSI value and a certain TOI value has a file name indicating an audio segment (e.g., a file name ending with “aac”), the UE determines that such object corresponds to an audio segment.

In an aspect, the one or more audio transmissions comprise a plurality of audio transmissions, and the UE determines the timing of each of the one or more audio transmissions by determining a start time of one or more additional transmissions of one or more additional data segments based the determined start time and based on a segment duration. For example, as discussed supra, in one configuration when an audio segment is transmitted first in each DASH segment duration, t0 represents the start time of the transmission of the first audio segment and corresponds to the time of receipt of the IP packet with SBN=0 and ESI=0. For example, as discussed supra, an expected start time of later audio packet transmissions tₐₙ=t0+DASH segment duration*n, where n is an integer number representing the nth+1 audio packet. In an aspect, the UE refrains from tuning away from the first RAT to the second RAT for an audio transmission of the at least one audio transmission between a first time and a second time, the first time being equal to the start time of the transmission of an audio segment minus a first threshold, the second time being equal to the start time of the transmission of the audio segment plus a second threshold, the second threshold being greater than or equal to a time duration for the audio transmission of the audio segment. For example, as discussed supra, the UE may refrain from tuning away some time before a start of the transmission of an audio segment. For example, as discussed supra, the UE may refrain from tuning away at an end of the transmission of the audio segment or may continue to refrain from tuning away for some time after the end of the transmission of the audio segment. For example, as discussed supra, the UE may refrain from tuning away for the time interval [t−d, t+D], where t is an expected start time of an audio segment transmission, d is a first duration, and D is a second duration. For example, as discussed supra, the second duration D is set to be large enough to cover the duration of audio segment transmission time.

In an aspect, the UE refrains from tuning away from the first RAT to the second RAT during an MTCH transmission interval corresponding to each of the at least one audio transmission. For example, as discussed supra, the second duration D may be an absolute time value or a time running only during an MTCH transmission interval. In an aspect, the UE refrains from tuning away from the first RAT to the second RAT during an MSP corresponding to each of the at least one audio transmission. For example, as discussed supra, the UE may refrain from tuning away for an entire MSP in which a transmission of an audio object occurs.

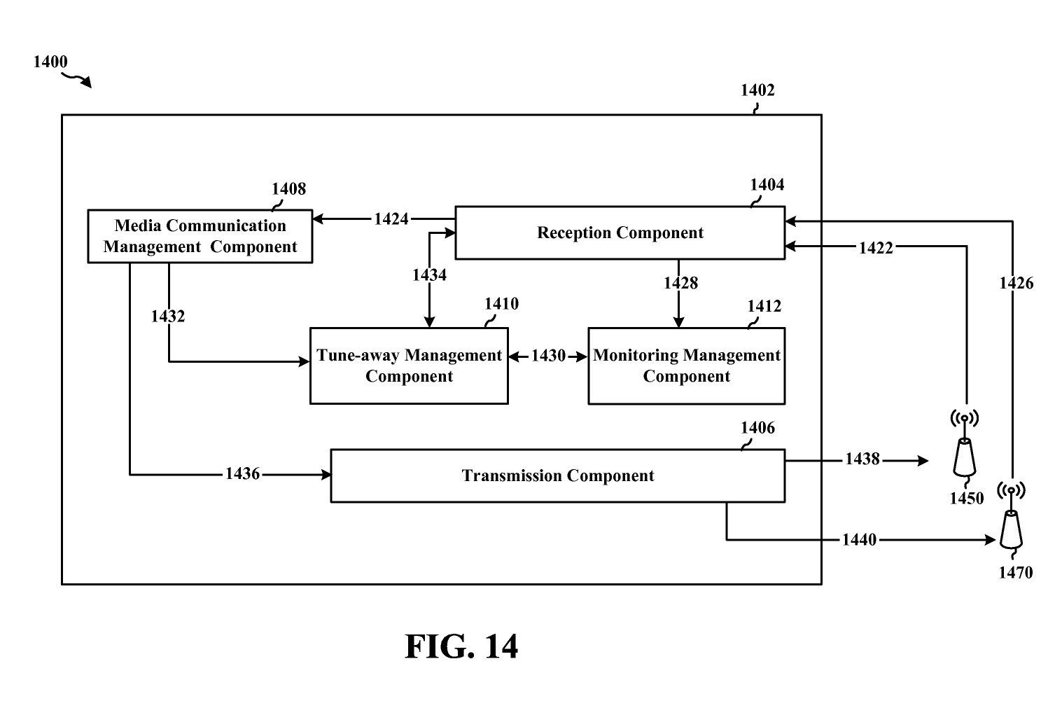

FIG. 14 is a conceptual data flow diagram 1400 illustrating the data flow between different means/components in an exemplary apparatus 1402. The apparatus may be a UE. The apparatus includes a reception component 1404, a transmission component 1406, a media communication management component 1408, a tune-away management component 1410, and a monitoring management component 1412.

The media communication management component 1408 determines a timing of each of one or more audio transmissions of one or more audio segments through MBMS streaming via a first RAT (e.g., via a base station 1450), via the reception component 1404, where the MBMS streaming includes the one or more audio segments and one or more video segments, at 1422 and 1424. The monitoring management component 1412 determines a timing of a monitoring window to tune to the second RAT (e.g., served by a base station 1470), via the reception component 1404, at 1426 and 1428. The monitoring management component 1412 and the tune-away management component 1410 determine whether the timing of the monitoring window to tune to the second RAT overlaps with the timing of the at least one audio transmission, at 1430 and 1432. The tune-away management component 1410 refrains from tuning away from the first RAT to a second RAT during at least one audio transmission of the one or more audio transmissions, the second RAT being different than the first RAT, via the reception component 1404, at 1432 and 1434. In an aspect, the tune-away management component 1410 refrains from tuning away from the first RAT to the second RAT when the timing of the monitoring window to tune to the second RAT overlaps with the timing of the at least one audio transmission, at 1432, and 1434. In an aspect, the monitoring window is a paging window. In an aspect, the media communication management component 1408 may manage transmission from the apparatus 1402 to the base station 1450 at 1436 and 1438 and/or transmission from the apparatus 1402 to the base station 1470 at 1436 and 1440.

In an aspect, the media communication management component 1408 may determine the timing of each of the one or more audio transmissions by determining a start time of a transmission of a data segment based on a FLUTE header of an IP packet, and determining that the data segment is an audio segment, via the reception component 1404, at 1422 and 1424. In an aspect, the start time of the transmission of the data segment is determined based on an ESI in the FLUTE header. In such an aspect, the start time of the transmission of the data segment is determined further based on an SBN in the FLUTE header. In an aspect, the FLUTE header includes at least one of a TSI or a TOI, and the data segment is determined to be an audio segment based on the at least one of the TSI or the TOI. In an aspect, media communication management component 1408 may further receive at least one FDT associated with the at least one audio transmission, where the data segment is determined to be an audio segment based on information included in the at least one FDT, via the reception component 1404, at 1422 and 1424. In such an aspect, the information included in the at least one FDT comprises a file size of each of the one or more audio segments, and the data segment is determined to be an audio segment based on each file size in at least one the FDT. In such an aspect, the information included in the at least one FDT comprises a file name of each of the one or more audio segments, and the data segment is determined to be an audio segment based on each file name in the at least one FDT.

In an aspect, the one or more audio transmissions comprise a plurality of audio transmissions, and the media communication management component 1408 determines the timing of each of the one or more audio transmissions by determining a start time of one or more additional transmissions of one or more additional data segments based the determined start time and based on a segment duration, via the reception component 1404, at 1422 and 1424. In an aspect, the tune-away management component 1410 refrains from tuning away from the first RAT to the second RAT for an audio transmission of the at least one audio transmission between a first time and a second time, the first time being equal to the time start of the transmission of an audio segment minus a first threshold, the second time being equal to the start time of the transmission of the audio segment plus a second threshold, the second threshold being greater than or equal to a time duration for the audio transmission of the audio segment, at 1432 and 1434.

In an aspect, the tune-away management component 1410 refrains from tuning away from the first RAT to the second RAT during an MTCH transmission interval corresponding to each of the at least one audio transmission, at 1432 and 1434. In an aspect, the tune-away management component 1410 refrains from tuning away from the first RAT to the second RAT during an MSP corresponding to each of the at least one audio transmission, at 1432 and 1434.

The apparatus may include additional components that perform each of the blocks of the algorithm in the aforementioned flow charts of FIG. 13. As such, each block in the aforementioned flow charts of FIG. 13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof

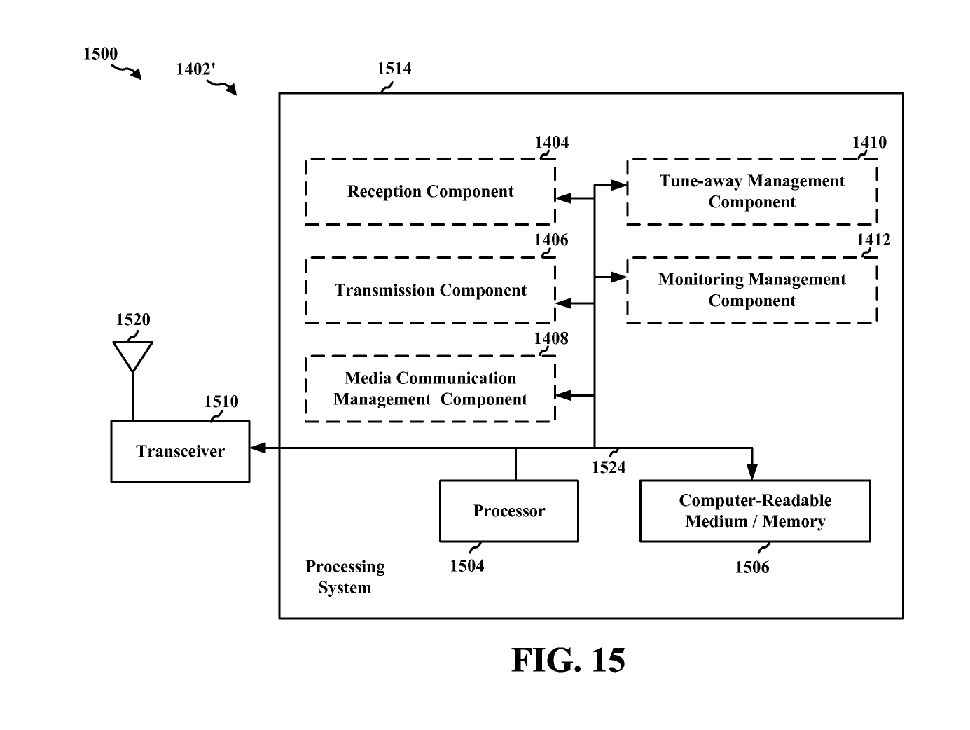

FIG. 15 is a diagram 1500 illustrating an example of a hardware implementation for an apparatus 1402′ employing a processing system 1514. The processing system 1514 may be implemented with a bus architecture, represented generally by the bus 1524. The bus 1524 may include any number of interconnecting buses and bridges depending on the specific application of the processing system 1514 and the overall design constraints. The bus 1524 links together various circuits including one or more processors and/or hardware components, represented by the processor 1504, the components 1404, 1406, 1408, 1410, 1412, and the computer-readable medium/memory 1506. The bus 1524 may also link various other circuits such as timing sources, peripherals, voltage regulators, and power management circuits, which are well known in the art, and therefore, will not be described any further.

The processing system 1514 may be coupled to a transceiver 1510. The transceiver 1510 is coupled to one or more antennas 1520. The transceiver 1510 provides a means for communicating with various other apparatus over a transmission medium. The transceiver 1510 receives a signal from the one or more antennas 1520, extracts information from the received signal, and provides the extracted information to the processing system 1514, specifically the reception component 1404. In addition, the transceiver 1510 receives information from the processing system 1514, specifically the transmission component 1406, and based on the received information, generates a signal to be applied to the one or more antennas 1520. The processing system 1514 includes a processor 1504 coupled to a computer-readable medium/memory 1506. The processor 1504 is responsible for general processing, including the execution of software stored on the computer-readable medium/memory 1506. The software, when executed by the processor 1504, causes the processing system 1514 to perform the various functions described supra for any particular apparatus. The computer-readable medium/memory 1506 may also be used for storing data that is manipulated by the processor 1504 when executing software. The processing system further includes at least one of the components 1404, 1406, 1408, 1410, 1412. The components may be software components running in the processor 1504, resident/stored in the computer readable medium/memory 1506, one or more hardware components coupled to the processor 1504, or some combination thereof. The processing system 1514 may be a component of the UE 650 and may include the memory 660 and/or at least one of the TX processor 668, the RX processor 656, and the controller/processor 659.

In one configuration, the apparatus 1402/1402′ for wireless communication includes means for determining a timing of each of one or more audio transmissions of one or more audio segments through MBMS streaming via a first RAT, where the MBMS streaming includes the one or more audio segments and one or more video segments, and means for refraining from tuning away from the first RAT to a second RAT during at least one audio transmission of the one or more audio transmissions, the second RAT being different than the first RAT. The apparatus 1402/1402′ may further include means for determining a timing of a monitoring window to tune to the second RAT, and means for determining whether the timing of the monitoring window to tune to the second RAT overlaps with the timing of the at least one audio transmission, where the means for refraining is configured to refrain from tuning away from the first RAT to the second RAT when the timing of the monitoring window to tune to the second RAT overlaps with the timing of the at least one audio transmission. In an aspect, the means for determining the timing of each of the one or more audio transmissions is configured to determine a start time of a transmission of a data segment based on a FLUTE header of an IP packet, and determine that the data segment is an audio segment. In an aspect, the means for determining the timing of each of the one or more audio transmissions is further configured to receive at least one FDT associated with the at least one audio transmission, wherein the data segment is determined to be an audio segment based on information included in the at least one FDT. In an aspect, the one or more audio transmissions may include a plurality of audio transmissions, and the means for determining the timing of each of the one or more audio transmissions may be configured to determine a start time of one or more additional transmissions of one or more additional data segments based the determined start time and based on a segment duration. The aforementioned means may be one or more of the aforementioned components of the apparatus 1402 and/or the processing system 1514 of the apparatus 1402′ configured to perform the functions recited by the aforementioned means. As described supra, the processing system 1514 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of blocks in the processes/flow charts disclosed is an illustration of exemplary approaches. Based upon design preferences, it is understood that the specific order or hierarchy of blocks in the processes/flow charts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for wireless communication of a user equipment (UE), comprising:
determining a timing of each of one or more audio transmissions of one or more audio segments through Multimedia Broadcast Multicast Service (MBMS) streaming via a first radio access technology (RAT), wherein the MBMS streaming includes the one or more audio segments and one or more video segments; and
refraining from tuning away from the first RAT to a second RAT during at least one audio transmission of the one or more audio transmissions, the second RAT being different than the first RAT.

2. The method of claim 1, further comprising:
determining a timing of a monitoring window to tune to the second RAT; and
determining whether the timing of the monitoring window to tune to the second RAT overlaps with the timing of the at least one audio transmission,
wherein the UE refrains from tuning away from the first RAT to the second RAT when the timing of the monitoring window to tune to the second RAT overlaps with the timing of the at least one audio transmission.

3. The method of claim 2, wherein the monitoring window is a paging window.

4. The method of claim 1, wherein the determining the timing of each of the one or more audio transmissions comprises:
determining a start time of a transmission of a data segment based on a file delivery over unidirectional transport (FLUTE) header of an Internet protocol (IP) packet; and
determining that the data segment is an audio segment.

5. The method of claim 4, wherein the start time of the transmission of the data segment is determined based on an encoding symbol identifier (ESI) in the FLUTE header.

6. The method of claim 5, wherein the start time of the transmission of the data segment is determined further based on a source block number (SBN) in the FLUTE header.

7. The method of claim 4, wherein the determining the timing of each of the one or more audio transmissions further comprises receiving at least one file delivery table (FDT) associated with the at least one audio transmission, wherein the data segment is determined to be an audio segment based on information included in the at least one FDT.

8. The method of claim 7, wherein the information included in the at least one FDT comprises a file size of each of the one or more audio segments, and wherein the data segment is determined to be an audio segment based on each file size in the at least one FDT.

9. The method of claim 7, wherein the information included in the at least one FDT comprises a file name of each of the one or more audio segments, and wherein the data segment is determined to be an audio segment based on each file name in the at least one FDT.

10. The method of claim 4, wherein the FLUTE header includes at least one of a transport session identifier (TSI) or a transport object identifier (TOI), and the data segment is determined to be an audio segment based on the at least one of the TSI or the TOI.

11. The method of claim 4, wherein the one or more audio transmissions comprise a plurality of audio transmissions, and wherein the determining the timing of each of the one or more audio transmissions further comprises determining a start time of one or more additional transmissions of one or more additional data segments based the determined start time and based on a segment duration.

12. The method of claim 4, wherein the UE refrains from tuning away from the first RAT to the second RAT for an audio transmission of the at least one audio transmission between a first time and a second time, the first time being equal the start time of the transmission of an audio segment minus a first threshold, the second time being equal to the start time of the transmission of the audio segment plus a second threshold, the second threshold being greater than or equal to a time duration for the audio transmission of the audio segment.

13. The method of claim 1, wherein the UE refrains from tuning away from the first RAT to the second RAT during a multicast traffic channel (MTCH) transmission interval corresponding to each of the at least one audio transmission.

14. The method of claim 1, wherein the UE refrains from tuning away from the first RAT to the second RAT during a multicast channel scheduling period (MSP) corresponding to each of the at least one audio transmission.

15. A user equipment (UE) for wireless communication, comprising:
a memory; and
at least one processor coupled to the memory and configured to:
determine a timing of each of one or more audio transmissions of one or more audio segments through Multimedia Broadcast Multicast Service (MBMS) streaming via a first radio access technology (RAT), wherein the MBMS streaming includes the one or more audio segments and one or more video segments; and
refrain from tuning away from the first RAT to a second RAT during at least one audio transmission of the one or more audio transmissions, the second RAT being different than the first RAT.

16. The UE of claim 15, wherein the at least one processor is further configured to:
determine a timing of a monitoring window to tune to the second RAT; and
determine whether the timing of the monitoring window to tune to the second RAT overlaps with the timing of the at least one audio transmission,
wherein the UE refrains from tuning away from the first RAT to the second RAT when the timing of the monitoring window to tune to the second RAT overlaps with the timing of the at least one audio transmission, and
wherein the monitoring window is a paging window.

17. The UE of claim 15, wherein the at least one processor configured to determine the timing of each of the one or more audio transmissions is configured to:
determine a start time of a transmission of a data segment based on a file delivery over unidirectional transport (FLUTE) header of an Internet protocol (IP) packet; and
determine that the data segment is an audio segment.

18. The UE of claim 17, wherein the start time of the transmission of the data segment is determined based on an encoding symbol identifier (ESI) in the FLUTE header, and
wherein the start time of the transmission of the data segment is determined further based on a source block number (SBN) in the FLUTE header.

19. The UE of claim 17, wherein the at least one processor configured to determine the timing of each of the one or more audio transmissions is further configured to receive at least one file delivery table (FDT) associated with the at least one audio transmission, wherein the data segment is determined to be an audio segment based on information included in the at least one FDT.

20. The UE of claim 19, wherein the information included in the at least one FDT comprises a file size of each of the one or more audio segments, and wherein the data segment is determined to be an audio segment based on each file size in the at least one FDT.

21. The UE of claim 19, wherein the information included in the at least one FDT comprises a file name of each of the one or more audio segments, and wherein the data segment is determined to be an audio segment based on each file name in the at least one FDT.

22. The UE of claim 17, wherein the FLUTE header includes at least one of a transport session identifier (TSI) or a transport object identifier (TOI), and the data segment is determined to be an audio segment based on the at least one of the TSI or the TOI.

23. The UE of claim 17, wherein the one or more audio transmissions comprise a plurality of audio transmissions, and wherein the at least one processor configured to determine the timing of each of the one or more audio transmissions is configured to determine a start time of one or more additional transmissions of one or more additional data segments based the determined start time and based on a segment duration.

24. The UE of claim 17, wherein the UE refrains from tuning away from the first RAT to the second RAT for an audio transmission of the at least one audio transmission between a first time and a second time, the first time being equal to the start time of the transmission of an audio segment minus a first threshold, the second time being equal to the start time of the transmission of the audio segment plus a second threshold, the second threshold being greater than or equal to a time duration for the audio transmission of the audio segment.

25. The UE of claim 15, wherein the UE refrains from tuning away from the first RAT to the second RAT during a multicast traffic channel (MTCH) transmission interval corresponding to each of the at least one audio transmission.

26. The UE of claim 15, wherein the UE refrains from tuning away from the first RAT to the second RAT during a multicast channel scheduling period (MSP) corresponding to each of the at least one audio transmission.

27. A user equipment (UE) for wireless communication, comprising:
means for determining a timing of each of one or more audio transmissions of one or more audio segments through Multimedia Broadcast Multicast Service (MBMS) streaming via a first radio access technology (RAT), wherein the MBMS streaming includes the one or more audio segments and one or more video segments; and
means for refraining from tuning away from the first RAT to a second RAT during at least one audio transmission of the one or more audio transmissions, the second RAT being different than the first RAT.

28. The UE of claim 27, further comprising:
means for determining a timing of a monitoring window to tune to the second RAT; and
means for determining whether the timing of the monitoring window to tune to the second RAT overlaps with the timing of the at least one audio transmission,
wherein the means for refraining is configured to refrain from tuning away from the first RAT to the second RAT when the timing of the monitoring window to tune to the second RAT overlaps with the timing of the at least one audio transmission, and
wherein the monitoring window is a paging window.

29. A computer-readable medium storing computer executable code for wireless communication, comprising code for:
determining a timing of each of one or more audio transmissions of one or more audio segments through Multimedia Broadcast Multicast Service (MBMS) streaming via a first radio access technology (RAT), wherein the MBMS streaming includes the one or more audio segments and one or more video segments; and
refraining from tuning away from the first RAT to a second RAT during at least one audio transmission of the one or more audio transmissions, the second RAT being different than the first RAT.

30. The computer-readable medium of claim 29, further comprising code for:
determining a timing of a monitoring window to tune to the second RAT; and
determining whether the timing of the monitoring window to tune to the second RAT overlaps with the timing of the at least one audio transmission,
wherein the computer-readable medium comprising code for refraining from tuning away from the first RAT to the second RAT during the at least one audio transmission comprises code for refraining from tuning away from the first RAT to the second RAT when the timing of the monitoring window to tune to the second RAT overlaps with the timing of the at least one audio transmission, and
wherein the monitoring window is a paging window.
